(19) United States
(12) Patent Application Publication
(10) Pub. No.: US 2007/0261369 A1
(43) Pub. Date: Nov. 15, 2007

(54) Bottle turn prevention mechanism for neck grippers

(75) Inventors: Younosuke Takahara, Yokohama-shi (JP); Nobuyuki Ueda, Yokohama-shi (JP); Jun Wakishima, Yokohama-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOYO SEIKAN KAISHA, LTD., Chiyoda-ku (JP)

(21) Appl. No.: 11/429,963

(22) Filed: May 9, 2006

(51) Int. Cl. B67B 1/06

(52) U.S. Cl. 53/317

(57) ABSTRACT

A bottle turn prevention mechanism for neck grippers which hold a neck of a bottle 1 from both sides by means of neck grippers 2, 3, wherein contacting sections which contact the neck are continuous with non-contacting sections which do not contact the neck, boundary sections where the non-contacting sections change into the contacting sections in the direction of the rotational force which the bottle receives during capping are formed in acute-angled shapes with respect to the outer circumferential surface of the neck, and this acute-angled shape is formed in such a manner that the angle α formed between the line L₁ linking the front end section 2c, 3c of the boundary section and the center line of the neck, and the tangent L₂ to the front end section of the non-contact surface side, lies in the range 0°<α≦45°.

### BACKGROUND OF THE INVENTION

1. Field of the Invention

The present invention relates to grippers which hold a neck of a bottle so that the bottle does not turn, when securing a lid onto the bottle opening of an elastic bottle, such as a polyethylene terephthalate (PET) bottle.

2. Description of the Related Art

Publication of unexamined utility model application No. H8-6794 presents models of two mechanisms for preventing turning of a bottle when securing a threaded cap on a blow-molded plastic bottle, by means of a screw fastening action. More specifically, the neck of the bottle engages with a concave portion in a rotating disk, a lid is provisionally placed on the bottle, and in this state, the bottle is sent to a capper, where it is capped and then sent to a bottle discharge device. One of the aforementioned mechanisms is designed to prevent rotation of the bottle during capping by causing rigid projections provided on the upper surface of the periphery of a concave portion in a rotating disk for bottle transportation to bite into the lower surface of a support ring provided on the plastic bottle. The other mechanism prevents turning of the bottle during capping by providing a touch plate in line with the rotating disk, the touch plate being caused to touch the bottle neck, and integrally forming one or more projections like cross-sectional triangle, in respective concave portion of a rotating disk, these projections being made to bite into the bottle neck in a perpendicular direction with respect to the direction of rotation. Recently, the general mode of holding a bottle during lid fastening has come to be a mode using a gripper which holds and transports the neck of the bottle from the external circumferential direction, rather than a mode in which the bottle engages with a concave portion in a rotating disk. A capping head holds a lid against the opening of a bottle held by one pair of grippers, and it fastens the lid onto the opening by rotating and lowering the lid from above. In current practice, there are two types of grippers which hold the neck of the bottle in order that the bottle does not turn when a lid is fastened onto the bottle opening, these types of grippers having developed from the two mechanisms described above, namely, 1) a mechanism in which acute-angled projections are installed on the upper surface of a neck gripper; and 2) a mechanism in which acute-angled projections are installed on the inner surface of a neck gripper.

In the former mechanism, in which acute-angle projections are installed on the upper surface of a neck gripper, arc-shaped notch sections 2a and 3a are provided at the front end sections of the pair of left and right-hand grippers 2 and 3 in order to hold the neck of a bottle as shown in FIG. 4-A, and acute-shaped projections 2b and 3b are provided in a radial direction on the upper surface of the notch sections 2a and 3a. At the opening of the bottle 1, a neck ring 1a is provided on the neck in the form of a flange as shown in FIG. 4-B, and a spiral-shaped projection 1b which screws together with the lid 6 is formed on the outer circumferential surface of the front end portion of the opening of the bottle 1. When the neck of the bottle is held by the arc-shaped notch sections 2a and 3a of the pair of grippers 2, 3, then the acute-angled projections 2b and 3b assume a state of contact with the lower surface of the neck ring la as shown in FIG. 4-C. In order to screw the bottle together with the lid while receiving pressure on the under side of the lid during the screw fastening operation, the acute-angled projections 2b and 3b press against and bite into the lower surface of the neck ring 1a, thereby preventing rotation.

However, this mechanism has problems in that: a) the rear surface of the neck ring is scratched due to contact with the rotation preventing projections, when the bottle is introduced into the neck grippers; b) an error may occur in the introduction operation. In order to prevent this, the feed line is displaced upwards or downwards, but the bottle becomes unstable in the transfer position. c) The bottle is liable to turn at the start of screw fastening because the top load is small, and hence the rear surface of the neck ring is scratched. d) The top load must be adjusted when the screw fastening torque becomes large. e) Since the shape of the projections is difficult to process, it is necessary to form the projections detachably, and hence processing costs increase. Furthermore, gaps are liable to arise in the installation positions and these may become sources of contamination by bacteria. Moreover, f) since a frictional resistance sufficient to. prevent turning cannot be obtained unless the bottle is pressed strongly from above, then if there is variation in the bottle height, or if the force pressing on the bottle from above is small, a sufficient effect in preventing turning of the bottle cannot be achieved.

In the latter mechanism in which acute-angled projections are-situated on the inner surface of the neck grippers, as shown in FIG. 5-A, arc-shaped notch sections 2a and 3a for gripping the neck of a bottle are provided in the vicinity of the front end section of a pair of left and right-hand grippers 2, 3, and in the example shown here, acute-angled projections 2b and 3b are provided in the thickness direction on the inner circumferential surface, as illustrated in FIG. 5-B which shows an enlarged view of the inner surface of the neck grippers. FIG. 5-C shows a local enlarged view of a projection 3b. As these figures reveal, the projection 3b provided on the inner circumferential surface of the gripper 3 has a front tip inclined at an angle in order that it readily bites into the bottle 1 when the bottle receives a turning force in the clockwise direction.

However, this mechanism has problems in that: a) the neck becomes scratched due to contact with the rotation preventing projections, when the bottle is introduced into the neck grippers; b) an error may occur in the introduction operation. In order to prevent problems a) and b), it is necessary to open the neck grippers widely in the transfer section, but in this case, there is a problem in that the transfer of the bottle becomes unstable. c) The bottle neck becomes scratched due to the acute-angle projections touching the bottle. d) The top load must be adjusted when the screw fastening torque becomes large. e) Since the shape of the projections is difficult to process, it is necessary to form the projections detachably, and hence processing costs increase. Furthermore, there is also a problem in that gaps are liable to arise in the installation positions and these may become sources of contamination by bacteria.

### SUMMARY OF THE INVENTION

The object of the present invention is to provide a capping mechanism whereby problematic biting scratches are not caused in a bottle during capping, special adjustments are not required when the screw fastening torque changes, and a bottle can be introduced without causing scratches to same, even if the opening of the neck grippers is small.

In order to achieve the aforementioned object, the bottle turn prevention mechanism for neck grippers according to the present invention is a mechanism which holds a neck of a bottle from both sides, wherein contacting sections which make contact with the neck are continuous with non-contacting sections which do not make contact with same, and the boundary sections where the non-contacting sections change into the contacting sections in the direction of the rotational force which the bottle receives during capping are formed in acute-angled shapes with respect to the outer circumferential surface of the neck. Said one or more boundary sections formed in an acute-angled shape are formed respectively on each of the neck grippers of both sides. Furthermore, in this example, the boundary sections formed in acute-angled shapes are formed so as to be continuous in the thickness direction of the neck grippers. Moreover, the acute-angled shape is formed in such a manner that the angle a between the line linking the front end section of the boundary section and the center line of the neck, and the tangent to the front end section of the non-contact surface side, comes within the range of 0° <α≦45°. Furthermore, a contact region which is proximate to the boundary section formed in an acute-angled shape is designed to have a slightly larger outer diameter dimension than the contact diameter.

The bottle turn prevention mechanism for neck grippers according to the present invention is a bottle turn prevention mechanism for neck grippers which hold a neck of a bottle from both sides, wherein contacting sections which make contact with the neck are formed continuously with non-contacting sections which do not make contact with same, and boundary sections from the non-contacting sections to the contacting sections in the direction of the rotational force received by the bottle during capping are formed in acute-angled shapes with respect to the outer circumferential surface of the neck. Desirably, the acute-angled shape is formed in such a manner that the angle a between the line linking the front end section of the boundary section and the center line of the neck, and the tangent to the front end section of the non-contact surface side, comes within the range of 0° <α≦45°. Therefore, turning of the bottle is prevented in a mode where the front end sections of the acute-angled boundary sections only bite into the neck of the bottle during screw fastening, rather than having projections bite into the outer circumferential surface of the neck continuously. Therefore, even if the opening between the neck grippers is small, it is possible to introduce the bottle without causing scratching of the bottle, and hence no problematic biting scratches are caused to the bottle during capping. If the rotational torque increases, then the amount of biting also increases accordingly, thereby increasing the turn prevention function, and hence specific adjustments are not required when the screw fastening torque changes.

Furthermore, the bottle turn prevention mechanism for neck grippers according to the present invention, in which one or more boundary sections formed in an acute-angled shape are formed respectively on the neck-grippers of both sides, displays a turn prevention function with respect to the direction of rotation during the screw fastening action, at respective locations.

The bottle turn prevention mechanism for neck grippers according to the present invention, in which the boundary sections formed in acute-angled shapes are formed continuously in the thickness direction of the neck grippers, performs a turn prevention function effectively over the whole width of the neck with which it makes contact. Furthermore, by designing a contact region proximate to the boundary section formed in an acute-angled shape to have a slightly larger outer diameter dimension than the contact diameter, then biting by the proximate boundary section formed in an acute-angled shape is not impaired.

Moreover, by forming the boundary section with the non-contact region so as to retreat gently in the parts other than the front end section formed in an acute-angled shape, it does not create a biting effect, and when a force is applied in the counter-clockwise direction, the bottle neck slides and no scratches are caused to the bottle.

### BRIEF DESCRIPTION OF THE DRAWINGS

FIG. 1 is a diagram showing an embodiment of neck grippers according to the present invention;

FIG. 2-A, FIG. 2-B and FIG. 2-C are partial enlarged diagrams showing a characteristic feature of an embodiment of neck grippers according to the present invention;

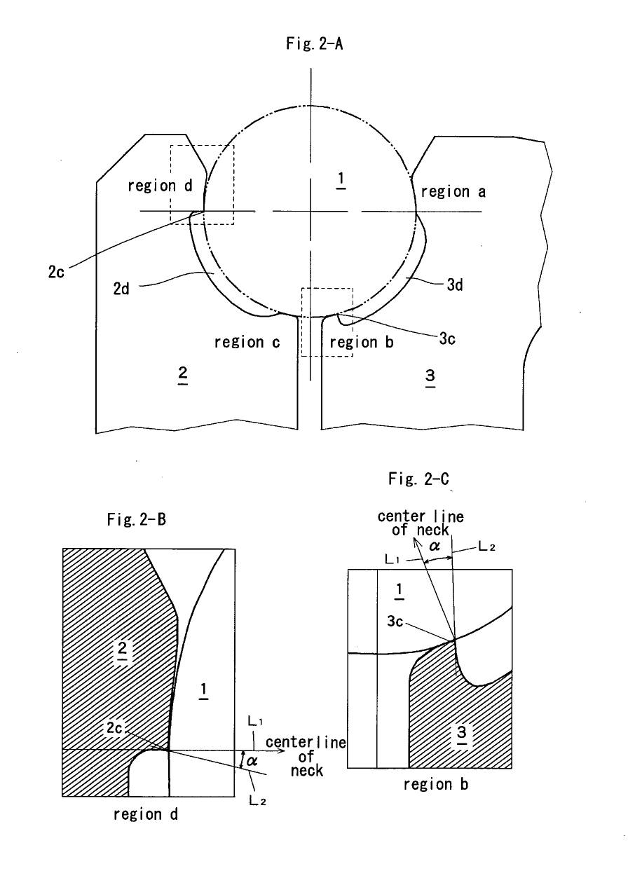

FIG. 3 is a diagram describing a capping step for a PET bottle;

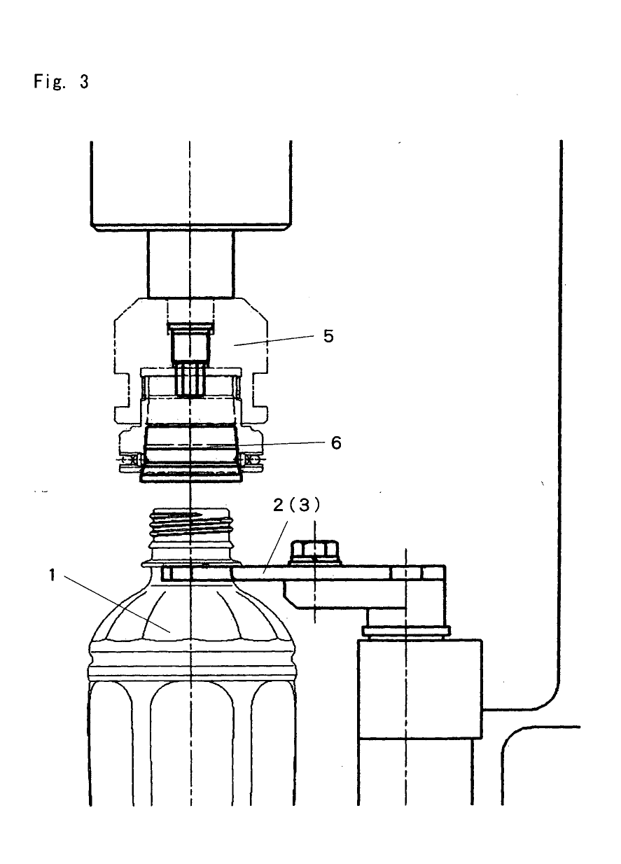

FIG. 4-A, FIG. 4-B and FIG. 4-C are diagrams describing one example of a mechanism in a conventional neck gripper; and

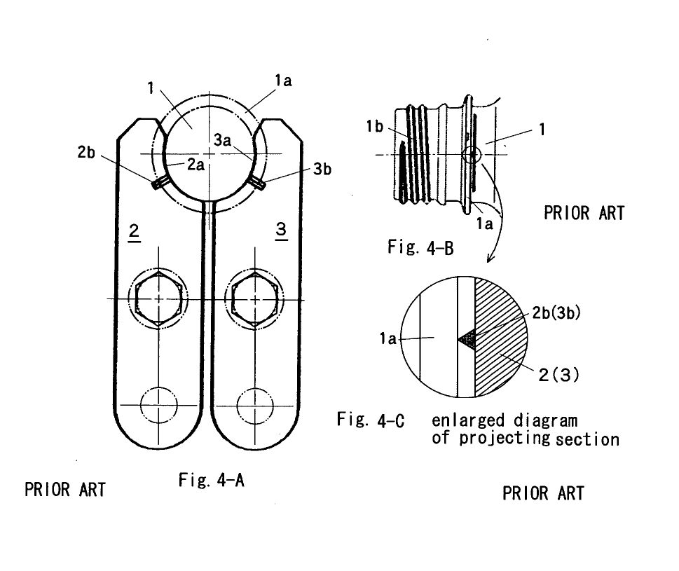

FIG. 5-A, FIG. 5-B and FIG. 5-C are diagrams describing a further example of a mechanism in a conventional neck gripper.

### DESCRIPTION OF THE PREFERRED EMBODIMENTS

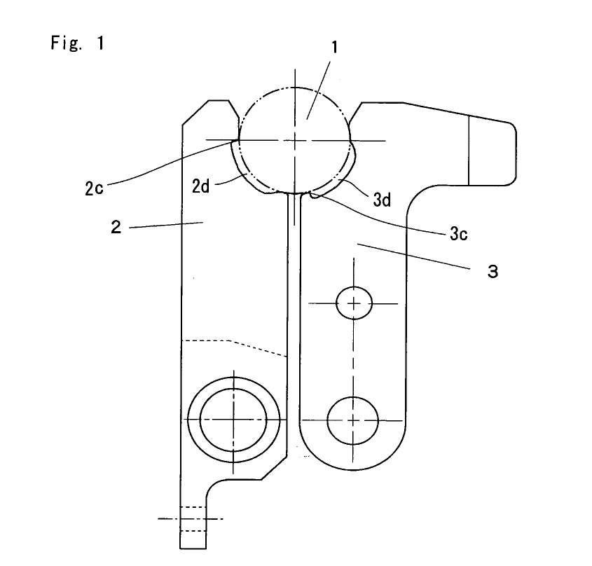

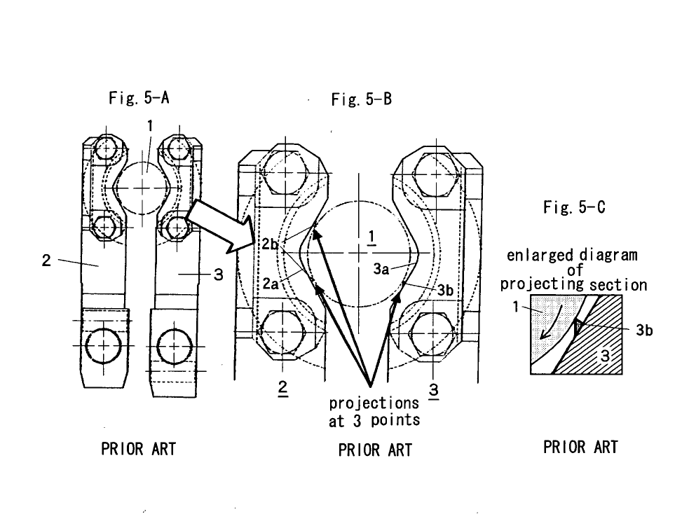

The bottle turn prevention mechanism for a neck gripper according to the present invention comprises a pair of neck grippers 2 and 3 as shown in FIG. 1, and the mode of gripping and holding the bottle 1 in notch sections at the front ends of these grippers is essentially similar to the prior art mechanism shown in FIGS. 5-A, 5-B and 5-C. The major point of difference lies in the fact that no projections are provided on the inner circumferential surfaces of the grippers, and contacting sections which make contact with the neck of the bottle 1, and non-contacting sections which do not make contact with same, are formed on these inner circumferential surfaces. In the example shown in the drawings, on the neck gripper 3 on one side, the contacting sections which make contact with the neck of the bottle 1 are formed by the region a and region b, and a concave portion 3d which does not make contact with the neck is formed between these two regions a and b. Furthermore, in the neck gripper 2 on the other side, the contacting sections which make contact with the neck of the bottle 1 are formed by the region c and the region d, and a concave portion 2d which does not make contact with the neck is formed between these two regions c and d. However, in practice, the outer diameter at the region c is formed to be slightly larger, for instance, 0.2 mm larger, than the outer diameter at the regions a, b and d. Therefore, when the neck of a bottle 1 is gripped between this pair of neck grippers 2 and 3, the first region c does not make contact with the outer surface of the neck, but the three regions a, b and d do make contact with the neck. These three points function as a centering guide, and decide the central position of the bottle 1.

During screw fastening of a lid 6, the bottle 1 receives a turning force in the clockwise direction, and therefore it is necessary for the neck grippers 2 and 3 to prevent that turning. Therefore, in the present invention, it was decided to adopt a special shape between the region b and the concave portion 3d of the non-contact region, and between the region d and the concave portion 2d of the non-contact region, thereby imparting a turn prevention function. More specifically, the front end sections 2c and 3c of the boundary sections where the non-contacting section changes into a contacting section in the direction of the rotational force received by the bottle during capping (namely, the direction of clockwise rotation in the example shown in the diagram), are formed so as to have an acute-angled shape with respect to the outer circumferential surface of the neck. By adopting these shapes, the outer circumferential surface of the neck does not make contact with projections on the neck grippers, as in the prior art example shown in FIGS. 5-A, 5-B and 5-C, during the process from gripping of the bottle 1 through to screw fastening, and therefore no scratches are made on the bottle 1. Since a rotational force is applied to the bottle 1 in a clockwise direction during screw fastening, the boundary sections where the non-contacting sections change into the contacting sections, in other words, the acute-angled shapes of the front end sections 3c and 2c of region b and region d in this example, bite into the outer circumferential surface of the neck of the bottle 1, thus preventing rotation of the bottle. Since the bottle 1 is flexible, rather than rigid, then in a state where it is gripped by the neck grippers, the bottle 1 deforms and swells slightly into the concave portions of the non-contacting regions. In this state, since the bottle receives a rotational force, the acute-angled shapes act as hooks, which bite into the outer circumferential surface of the neck of the bottle 1 and prevent it from turning. In this example, the boundary sections formed in this acute-angled shape are formed respectively, once each, at the end section of region b and the end section of region d, on both of the neck grippers, but there do not have to be limited to one in number and they may be disposed in a plurality of locations. It can be readily understood that the greater the number of biting points, the greater the effect in preventing turning.

Furthermore, in this example, the boundary sections formed in acute-angled shapes as described above are formed so as to be continuous in the thickness direction of the neck grippers. Thereby, the biting section becomes broader and the turn prevention effect is raised. Suitably, the angle a between the line L₁ linking the front end section 2c, 3c of the boundary section with the center line of the neck, and the tangent L₂ to the front end section of the non-contacting surface side, is designed to be within the range of 0° <α≦45°. In the present invention, by providing acute-angled shapes, the turn prevention function is made to take effect reliably when a rotational force acts during screw fastening, whereas there is no biting effect and slipping is liable to occur, when a rotational force acts in the opposite direction. More specifically, in the present embodiment, in the parts other than the front end sections 2c and 3c which are formed with acute-angled shapes, the boundary sections with the non-contacting regions are formed so as to retreat smoothly from the surface of the neck of the bottle, in order not to produce a biting effect. Here, a smoothly retreating shape is, for example, a smooth convex surface or concave surface formed to a diameter greater than the diameter of the bottle neck. The front end sections 2c, 3c formed with an acute-angled shape never bite into the bottle when a rotational force is applied in the counter-clockwise direction. Therefore, by ensuring that no rotational force is applied in the clockwise direction during the holding of the bottle by the neck grippers, or during release from same, then there is no risk of causing scratches to the bottle. Moreover, if the screw fastening torque is increased, then the biting action of the hook-shaped acute-angled sections increases accordingly, and hence it is possible to prevent turning of the bottle, without special adjustment.

In this example, the reason for forming the outer diameter of the region c to be 0.2 mm larger than the outer diameter of the regions a, b and d is that the region c has a close positional relationship with respect to region b, and hence there is a risk that the biting state will become shallow at region b if it makes contact with the outer circumferential surface of the bottle 1 in this section.

As described above, the technology of the present invention is applied to a screw fastening step for a PET bottle, or the like, which is widely used as a container for soft drinks, and the like, and it provides a capping mechanism whereby problematic biting scratches are not caused in a bottle during capping, special adjustments are not required when the screw fastening torque changes, and a bottle can be introduced without causing scratches to same, even if the opening of the neck grippers is small.

Furthermore, in the foregoing description, the neck grippers of the present invention grip the portion below a neck ring in the neck of a bottle, but the present invention is not limited to this, and it may also be implemented in a mode where it grips the neck ring section of a bottle.

What is claimed is:

1. A bottle turn prevention mechanism for neck grippers which hold a neck of a bottle from both sides, wherein contacting sections which make contact with the neck are continuous with non-contacting sections which do not make contact with same, and boundary sections where the non-contacting sections change into the contacting sections in the direction of the rotational force which the bottle receives during capping are formed in acute-angled shapes with respect to the outer circumferential surface of the neck.

2. The bottle turn prevention mechanism for neck grippers according to claim 1, wherein said one or more boundary sections formed in an acute-angled shape are formed respectively on the neck grippers of both sides.

3. The bottle turn prevention mechanism for neck grippers according to claim 1, wherein the boundary sections formed in an acute-angled shape are formed continuously in the thickness direction of the neck grippers.

4. The bottle turn prevention mechanism for neck grippers according to claim 2, wherein the boundary sections formed in an acute-angled shape are formed continuously in the thickness direction of the neck grippers.

5. The bottle turn prevention mechanism for neck grippers according to claim 1, wherein the acute-angled shape is formed in such a manner that the angle a between the line linking the front end section of the boundary section and the center line of the neck, and the tangent to the front end section of the non-contact surface side, comes within the range of 0°<α≦45°.

6. The bottle turn prevention mechanism for neck grippers according to claim 1, wherein a contact region proximate to the boundary section formed in an acute-angled shape has a slightly larger outer diameter dimension than the contact diameter.

7. The bottle turn prevention mechanism for neck grippers according to claim 1, wherein the boundary sections with the non-contacting regions are formed so as to retreat smoothly, in the parts other than the front end sections formed in an acute-angled shape.
